(19) United States
(12) Patent Application Publication
(10) Pub. No.: US 2009/0062153 A1
(43) Pub. Date: Mar. 5, 2009

(54) Enzyme enhanced oil/gas recovery (EEOR/EEGR) using non-gel hydraulic fracturing in hydrocarbon producing wells

(76) Inventors: John L. Gray, Houston, TX (US); Allan R. Hartman, Cuero, TX (US); Ronald Michael Herzfeld, Austin, TX (US)

Correspondence Address: GUERRY LEONARD GRUNE, 784 S VILLIER CT., VIRGINIA BEACH, VA, 23452, US

(21) Appl. No.: 11/897,191

(22) Filed: Aug. 29, 2007

(51) Int. Cl. C09K 8/62; E21B 43/22; E21B 43/27

(52) U.S. Cl. 507/201; 166/177.5

(57) ABSTRACT

The present application describes enhanced recovery of oil and/or other hydrocarbons in a subterranean formation such that oil and/or hydrocarbons are released by a hydraulic fracturing process with a non-gel hydraulic fracturing fluid that comprises an oleophilic enzyme thereby forming a non-gel hydraulic fracturing fluid enzyme composition which is injected during an initial or later stage.

### FIELD OF DISCLOSURE

The present disclosure relates to hydraulic fracturing in a subterranean reservoir and the use of enzymes. More specifically, it relates to the addition of oleophilic enzymes or non-living enzymes previously derived from “oil-loving” microbes that target the release of oil from the reservoir structure in combination with hydraulic fracturing without proppants or the addition of gels, thickeners, viscosifiers or cross-linked polymer additives.

### BACKGROUND OF DISCLOSURE

Hydrocarbons (oil, natural gas, etc.) are obtained from subterranean geologic formations by drilling a well that penetrates the formation. This provides a partial flowpath for the hydrocarbon to reach the surface. In order for the hydrocarbons to be produced, there must be a sufficiently unimpeded flowpath from the formation to the well bore to be pumped to the surface. Some wells require fracturing due to insufficient porosity or permeability as part of completing the well for initial production. Fracturing a new well provides sufficient channels for oil and gas to flow. In existing wells when the flow of hydrocarbons diminishes, hydraulic fracturing may take place to release more hydrocarbons for recovery.

Hydraulic fracturing is a stimulation treatment routinely performed on oil and gas wells in low-permeability reservoirs. Specially engineered fluids are pumped at high pressure and rate into the reservoir interval to be treated, causing a vertical fracture to open. The wings of the fracture extend away from the wellbore in opposing directions according to the natural stresses within the formation. Proppant, such as grains of sand of a particular size, is mixed with the treatment fluid to keep the fracture open when the treatment is complete. Hydraulic fracturing creates high-conductivity communication with a large area of formation and bypasses any damage that may exist in the near-wellbore area.

Hydraulic fracturing is one of the petroleum (oil and gas) industry's most complex operations. Applied in an effort to increase the well productivity, in a typical procedure, fluids containing propping agents are pumped into a well at high pressures and injection rates high enough to build up sufficient stress to overcome the earth compression stress holding the rock material together. The rock then parts or fractures along a plane perpendicular to the minimum compressive stress in the formation matrix.

Many oil and gas wells require hydraulic fracturing to create channels to allow oil and gas to flow. As defined above, hydraulic fracturing employs fluids that have proppants, such as sand, but also may have gels, thickening agents and/or cross-linked polymers to support the materials within the oil reservoir. The purpose of the additives in the fracturing fluid is to solidify, with an amount of permeability, holding the fissures open to enable the oil to flow more easily from the reservoir material. Oil well depth, geological formation, type of fracturing fluids and other additives in the fracturing procedure, may indicate the need to use significant pressure to fracture the formation and to achieve full infiltration of the fracturing fluid.

Several problems have become associated with such processes, especially with regard to the placement of propping agents in fractures. For example, if too little proppant is used, under infiltration can occur where the fracture is not completely filled with propping agent in the near wellbore region. This greatly reduces productivity due to the closure stresses at the mouth of the fracture near the wellbore. Such problems have been shown to cause the fracture to close upon incomplete fracture fill-up due to the high stress level in the near wellbore region, thereby reducing the effectiveness of the treatment. Similarly, over displacement can occur if too large a volume of propping agent is used, causing proppant to settle in the wellbore itself and cover well perforations, thereby potentially limiting and reducing well productivity.

Another drawback of the fracturing jobs in high permeability formations is that they often result in high skin damage. The skin is the area of the formation adjacent to the bore hole that is often damaged by the invasion of foreign substances, principally fluids, used during drilling and completion operations, including a fracturing treatment. With a guar-base fluid, the “foreign substances” are essentially the polymers or the residues left by the gel breakers, additives developed for reducing the viscosity of the gel at the end of the fracturing treatment by cleaving the polymer into small molecules fragments. These substances create a thin barrier, called a skin, between the wellbore and the reservoir. This barrier causes a pressure drop around the wellbore that is quantified by the skin factor. Skin factor is expressed in dimensionless units: a positive value denotes formation damage; a negative value indicates improvement. Obviously, with the higher concentration of gelling agent, there is a greater the risk of damages and skins. In high permeability formations, this risk is a stronger force increasing the damage by the high proppant concentrations that are often used to obtain wider propped fractures. High skins can also result due to lack of not achieving a tip-screenout (TSO) wherein selected areas of the well are packed to stop fracturing.

After a viscosity fracturing fluid has been pumped into the formation and the fracturing of the formation has been obtained, it is desirable to remove the fluid from the formation to allow hydrocarbon production through the new fractures. Generally, the removal of the viscous fracturing fluid is realized by breaking the gel or emulsion or, in other words, by converting the fracturing fluid into a low viscosity fluid. Breaking the gelled or emulsified fracturing fluid has commonly been obtained by adding a breaker, that is, a viscosity-reducing agent, to the subterranean formation at the desired time. However, known techniques can be unreliable and at times result in incomplete breaking of the fluid and/or premature breaking of the fluid before the fracturing process is complete. Premature breaking can cause a decrease in the number of fractures obtained and thus, the amount of hydrocarbon recovery.

Gels, thickeners or polymers additives that assist in suspension and full infiltration of proppants, can pose a problem producing a phenomenon called “back out” of the formation once they've been fully dispensed. One way operators address this issue is to add encapsulated or liquid enzymes—that are gel, thickener or polymer specific—to degrade the bond in the additives. Petroleum Technology Digest (September 2000) refers to Polymer Specific Enzymes (PSE) that “reduce polymer-related drill-in fluid damage.” Most enzyme use in oilfields is some type of PSE that targets gels, thickeners or polymers additives for drilling mud, breaking up filter cake and for decomposing some type of cellulosic polymer or gel. PSEs are also known as “viscosity breakers”, “visc-breakers” or “breakers.”

The hydraulic fracturing process requires injecting the proppants and additives into the wellbore, pumping out the flowing oil or gas or some combination of hydrocarbon fluids, pumping in additional fluid and additives, such as a PSE to decompose the additives from the first injection and then pumping out the PSE should the need to perform another hydraulic fracturing cycle.

Therefore there is a need for an enzyme additive to the initial hydraulic fracturing fluid that is oil specific that allows the oil and gas to release from the surrounding oil reservoir structure leaving no residual additives in the reservoir or wellbore that have to be removed at a later date. Subsequent hydraulic fracturing with the enzyme does not require cleaning out remnants from the previous enzyme hydraulic fracturing cycle.

### RELEVANT ART

U.S. Pat. No. 7,213,651, to Brannon, et. al., and assigned to BJ Services, describes a method for fracturing a subterranean formation comprising: introducing a first treatment fluid having a first viscosity and a first density into the subterranean formation; and introducing a second treatment fluid having a second viscosity and a second density into the subterranean formation, wherein at least one of the first treatment fluid and the second treatment fluid comprise a proppant; the first treatment fluid creates a fluid segment extending through the subterranean formation; and the second fluid creates a finger or channel within the fluid.

U.S. Pat. No. 6,981,549, to Morales, et. al., and assigned to Schlumberger Technology Corp., describes a method of designing a hydraulic fracturing treatment in a subterranean reservoir comprising the steps of a) quantifying reservoir parameters including the bottom hole temperature and the formation permeability, b) injecting a calibration fluid, an acid, or any mixtures thereof, c) assessing the temporary variation in temperature of the formation due to the injection prior to a fracturing operation of the calibration fluid, the acid, or any mixtures thereof, and d) designing a treatment fluid optimized for said temporary temperature variation.

U.S. Pat. No. 5,226,479, to Gupta, et. al., and assigned to The Western Company of North America, describes a method of fracturing a subterranean formation comprised of: injecting a fracturing fluid and a breaker system into a formation to be fractured, said breaker system comprised of an enzyme component and y-butyrolactone; supplying sufficient pressure on the formation for a sufficient period of time to fracture the formation; after fracturing, adjusting the pH of the fluid with 7-butyrolactone whereby the enzyme component becomes active and capable of breaking the fluid; breaking the fluid with the enzyme component; and subsequently releasing the pressure on the formation.

U.S. Pat. No. 4,506,734, to Nolte, Kenneth G., and assigned to The Standard Oil Company, describes a method for reducing the viscosity of a fluid introduced into a subterranean formation, comprising: introducing under pressure a viscosity reducing chemical, contained within hollow or porous, crushable beads, and the fluid into said formation, and reducing said introduction pressure so any resulting fractures in said formation close and crush said beads, whereby the crushing of said beads releases said viscosity reducing chemical.

Chinese Publication No. 1,766,283, to Haifang Ge, and assigned to Dongying Shengshi Petroleum Technology Co. Ltd., describes an oil field oil-water well fracturing craft method of biological enzyme agent, which is characterized by the following: building the mixed biological enzyme agent and water or biological acid or antisludging agent or liquid nitrogen as fracturing fluid; forcing the fracturing fluid into the oil well or water well through the fracturing vehicle; pressing the fracturing fluid into the crack; opening the well after 72 hours. The biological enzyme agent penetrates the hole throat then enters into the microscopic hole gap, which attaches the rock surface and denudes the raw oil to improve the earth penetration factor. The method improves the water wet effect and washes the spalling oil film, which improves the recovery factor of raw oil.

### SUMMARY OF THE DISCLOSURE

One embodiment of the present disclosure includes an enhanced recovery of oil or other hydrocarbon deposits in a subterranean formation wherein the hydrocarbon deposits are releasable by hydraulic fracturing with a non-gel fracturing fluid that comprises an oleophilic enzyme in an initial or later stage addition thereby forming a hydraulic fracturing enzyme composition that is then connected to an injection and/or pressure pump for pumping the hydraulic fracturing fluid composition into a subterranean formation through an injection well with sufficient rate and pressure to fracture the formation, optionally followed by an additional period of time allowing the hydraulic fracturing fluid composition to soak in the subterranean formation wherein the oleophilic enzyme reduces the surface attraction between the hydrocarbons and the subterranean formation enabling the hydrocarbons to flow in the fissures created by the hydraulic fracturing process. The hydrocarbon flow from the subterranean formation to one or more producing wells within the subterranean formation is followed by recovery of the hydrocarbon by pumping or other methods from the subterranean formation.

Another embodiment of the present disclosure involves a method for performing hydraulic fracturing in either vertical or horizontal newly drilled or producing wells with an application, such as KCl, sand, or non-gel fracturing additives that include oleophilic or “oil loving” enzymes that target hydrocarbons including oil, asphaltenes, distillate, waxes and other hydrocarbons in a variety of different placements and mixtures within a non-gel hydraulic fracture. The specific function of the enzymes includes reduction of interfacial tension, improved wettability, and optimized release of oil from solid surfaces.

Another embodiment of the present disclosure is hydraulic fracturing enzyme that is oleophilic that improves mobility of the oil and provides better relative permeability as oil and gas is produced.

Another embodiment of the present disclosure is a method for performing hydraulic fracturing that does not require the use of viscosity-breakers or removal of polymer-related damage after the hydraulic fracturing has taken place because there are no gels, thickeners, viscosifiers or cross-linked polymers additives introduced into the original hydraulic fracturing process.

Another embodiment of the present disclosure is a method for performing hydraulic fracturing such that the addition of oleophilic enzymes assists with the pumping of the fracturing fluids by reducing surface tension and improving effective displacement of the fluids in some subterranean formations.

Another embodiment of the present disclosure is a method for performing hydraulic fracturing wherein there is an improvement in the sustainability of production by enhancing the mobility of the oil and eliminating the need for removal of polymer-related damages post fracturing.

Another embodiment of the present disclosure is a method for performing hydraulic fracturing wherein the oleophilic enzyme fluid breaks up and mobilizes hydrocarbon deposits that restrict flow of oil and gas to the producing well along the full length of the fractures.

Another embodiment of the present disclosure is a method for performing hydraulic fracturing wherein the oleophilic enzyme fluid is injected at ambient temperature or can be injected pre-heated to 80-90 degrees C. (174-194 degrees F.).

Another embodiment of the present disclosure is a method for performing hydraulic fracturing wherein the oleophilic enzyme fluid is injected between 5-10% concentration of the enzyme in staged addition to the total make-up of the hydraulic fracturing fluid composition.

Another embodiment of the present disclosure is a method for performing hydraulic fracturing such that the oleophilic enzyme fluid may also be injected at different stages of the fracturing process and utilizing varied concentrations of the oleophilic enzyme within the fluid.

Another embodiment of the present disclosure is a method for performing hydraulic fracturing wherein the oleophilic enzyme fluid is allowed to soak in situ before production is resumed.

Another embodiment of the present disclosure is a method for performing hydraulic fracturing wherein the oleophilic enzyme fluid is injected at a rate and pressure that is sufficient to fracture the formation.

Another embodiment of the present disclosure is a method for performing hydraulic fracturing such that the oleophilic enzyme fluid is incorporated into a non-gel hydraulic fracturing process designed specifically for an oil or gas well.

Another embodiment of the present disclosure is a method for performing hydraulic fracturing such that injecting the oleophilic enzyme fluid in a non-gel hydraulic fracture increases initial productivity through less resistance to flow of the oil and gas produced.

Another embodiment of the present disclosure is a method for performing hydraulic fracturing such that injecting the oleophilic enzyme fluid in a non-gel hydraulic fracture increases the longer-term production and recoverability of a well, extending the decline curve of a normal well for oil and gas production due to improved mobility of hydrocarbons in the fractures.

Another embodiment of the present disclosure is a method for performing hydraulic fracturing such that injecting the oleophilic enzyme fluid down open wellbore sections coats the wellbore, providing reduced surface tension and improving mobility and flow of oil to and within the wellbore.

Another embodiment of the present disclosure is a method for performing hydraulic fracturing such that injecting the oleophilic enzyme fluid into a non-gel frac treatment helps prevent near-wellbore blockage.

Another embodiment of the present disclosure is a method for performing hydraulic fracturing such that injecting the oleophilic enzyme fluid reduces the surface tension of oil and associated particulates within a well, which can block and restrict flow.

Another embodiment of the present disclosure is a method for performing hydraulic fracturing where the oleophilic enzyme fluid does not change the chemical composition of the petroleum based hydrocarbons to be extracted from the well.

Another embodiment of the present disclosure is a method for performing hydraulic fracturing where the oleophilic enzyme fluid is non-reactive with gas, but may release dissolved gas from oil.

Another embodiment of the present disclosure is a method for performing hydraulic fracturing where the oleophilic enzyme fluid decreases contact angles of oil and gas preventing oil or other hydrocarbon components from re-adhering to surfaces within the fractures.

Another embodiment of the present disclosure is a method for performing hydraulic fracturing where the oleophilic enzyme fluid does not ingest oil or alter the oil chemistry.

Another embodiment of the present disclosure is a method for performing hydraulic fracturing where the oleophilic enzyme fluid in water soluble and oil insoluble thus remaining active in the water phase to catalytically release oil.

Another embodiment of the present disclosure is a method for performing hydraulic fracturing where the oleophilic enzyme fluid is used in an unrestrictive manner for non-gel fracturing by the American Petroleum Institute (API) gravity oil or other hydrocarbons produced.

Another embodiment of the present disclosure is a method for performing hydraulic fracturing where the oleophilic enzyme fluid possesses heat tolerance within oil and gas wells up to 270 degrees C. under pressure.

### DESCRIPTION OF THE DRAWINGS

FIG. 1 is a schematic of the non-gel enzymatic hydraulic fracturing process for a subterranean formation [100] that has been producing oil [105] or other hydrocarbon(s) [110] utilizing a production well [115].

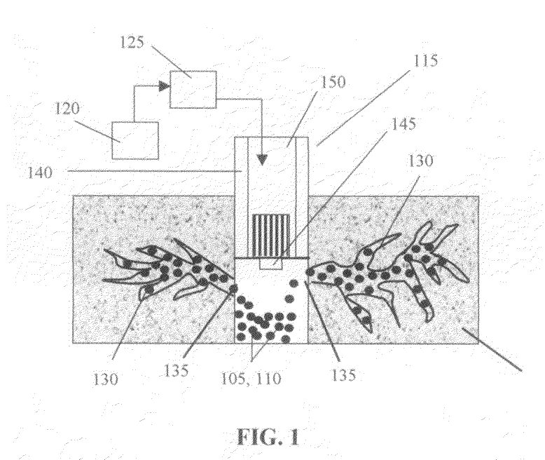

The oleophilic enzyme fluid [120] is prepared and pumped into an injection pump [125] when the production well [115] is stopped and sealed off. The injection pump [125] then injects the oleophilic enzyme fluid [120] which may contain other non-gel fluids as well as proppants at a rate and hydraulic pressure that is sufficient to fracture the subterranean formation [100], through perforations or open hole sections of the wellbore area [135]. The fissures [130] that are formed by the hydraulic pressure fracturing allow the oleophilic enzyme fluid [120] to permeate the fissures [130] and contact the oil [105] or other hydrocarbon(s) [110] and the subterranean formation [100] composition. The oleophilic enzyme fluid [120] reduces the attraction of the oil [105] or other hydrocarbon(s) [110] to solid surfaces in the subterranean formation [100] allowing the oil [105] or other hydrocarbon(s) [110] to flow through the fissures [130] toward the wellbore area [135] where the production well [115] flows or pumps the oil [105] or other hydrocarbon(s) [110] to the surface for processing.

An option of this process is to allow the oleophilic enzyme fluid [120] which may contain other non-gel fluid and proppants to create fissures [130] and then allow the oleophilic enzyme fluid [120] to “soak” in the fissures [130] and surrounding subterranean formation [100] for a period of time thereby allowing further contact time and reduction of interfacial tension (IFT) of the oil [105] or other hydrocarbon(s) [110] before resumed pumping or flowing of total fluids including oil [105] or other hydrocarbon(s) [110] to the surface.

Another option is to pump the oleophilic enzyme fluid [120] down the casing annulus [140] using the injection pump [125], without the use of a packer [145], having the tubing [150] shut in with fluid loaded to the surface. The fissures [130] that are formed allow the oleophilic enzyme fluid [120] to permeate the fissures [130] and contact the oil [105] or other hydrocarbons [110] in the subterranean formation [100]. After contacting and mobilizing the oil [105] and other hydrocarbons [110], they are then pumped or flowed up the tubing [150].

### DETAILED DESCRIPTION

Prior art describes use of enzymes as breakers for cross-linked polymers in fracturing fluids to degrade the additive compositions generally used in hydraulic fracturing. The following is a list of key differentiating characteristics defining an oleophilic enzyme fluid, such as Greenzyme®, for enzyme enhanced oil recovery (EEOR) in non-gel hydraulic fracturing:
1. Enzyme fluid is not a live microbe. It does not require nutrients. It is inert.
2. It does not grow or plug a formation. It does not ingest oil. It does not trigger any other downhole mechanism except its specific task to release oil from solid substrates.
3. Enzyme fluid is not designed to degrade or reduce viscosity. Its purpose is to improve oil and gas recovery by releasing oil and penetrating porous areas and reduce blockage thru these areas.
4. Enzyme fluid used in non-gel hydraulic fracturing does not target cross-linked polymers.
5. Enzyme fluid used in non-gel hydraulic fracturing does not target viscosity modifiers.
6. Enzyme fluid is not a chemical surfactant or polymer.
7. Enzyme fluid is this process is not used for remediation.
8. There is not a prescribed method or distribution of enzyme fluid in a formation. Addition of the enzyme fluid can vary depending on design of the non-gel treatment. This treatment does not contemplate fracturing or use of an acid treatment at the same time.
9. Enzyme fluid can be in liquid or encapsulated form as long its design and functionality does not target gels or specific cross-linked polymers.
10. No gels or cross-linked polymers are present in the hydraulic fracture treatment.

A hydraulic fracture is formed by pumping a non-gel fracturing fluid with KCl solution and sand into the wellbore at rate sufficient to increase the pressure downhole to a value in excess of the fracture gradient of the formation rock within the reservoir. Injection pressure needed is usually less than the pressure and pumping capabilities typically for a similar well using an admixture of fracturing fluid with a gel proppant additive. In the present disclosure an oleophilic enzyme is added to the hydraulic fracturing fluid initially and at various stages in a 5-10% concentration. The fluidic pressure then causes the subterranean formation to crack allowing the fracturing fluid with the oleophilic enzyme to enter the crack(s) thereby infiltrating the formation and contacting the oil entrapped within. The oleophilic enzyme is then allowed to soak in situ decreasing the adhesion of the oil to the formation, allowing oil to flow more readily into the wellbore where it is recovered.

The most significant benefit of this hydraulic fracturing method is that there are no gels, thickeners, viscosifiers or cross-linked polymers additives pumped into the wellbore, so there is no such additive or associated damage to clean out after recovering the oil thereby reducing the number of fracturing cycles.

Depending on the production response of the reservoir, the percentage of oleophilic enzymes may be increased or decreased in any subsequent fracturing cycles and the oleophilic enzymes can also be injected pre-heated to 80-90 degrees C. (174-194 degrees F.).

What is claimed is:

1. An enhanced recovery of oil and/or other hydrocarbons in a subterranean formation wherein said oil and/or hydrocarbons are releasable by a hydraulic fracturing process with a non-gel hydraulic fracturing fluid that comprises an oleophilic enzyme thereby forming a non-gel hydraulic fracturing fluid enzyme composition which is injected during an initial or later stage into a wellbore.

2. The hydraulic fracturing fluid enzyme composition of claim 1, wherein said composition is added to a pump for pressure pumping said composition into said subterranean formation through an injection well with sufficient pressure to fracture the formation, optionally followed by an additional period of time allowing said composition to soak in said subterranean formation and wherein said oleophilic enzyme within said composition reduces the surface attraction between said hydrocarbons and said subterranean formation enabling said hydrocarbons to flow within fissures created by said hydraulic fracturing process.

3. The hydraulic fracturing fluid enzyme composition of claim 1, wherein said hydrocarbons flow from said subterranean formation to one or more producing wells within said subterranean formation, followed by recovery from said subterranean formation of said hydrocarbons by pumping or other equivalent methods.

4. The hydraulic fracturing fluid enzyme composition of claim 1, wherein said composition may contain any other non-gel fluid and/or proppants useful for enhanced oil recovery.

5. The hydraulic fracturing fluid enzyme composition of claim 1, wherein said composition is GREENZYME® and wherein said hydrocarbon deposits include crude oil.

6. The hydraulic fracturing fluid enzyme composition of claim 1, wherein hydraulic fracturing is performed in a vertical or horizontal well with non-gel hydraulic fracturing fluid additives that include said oleophilic enzymes that target said oil and/or hydrocarbons including oil, asphaltenes, distillate, waxes and other hydrocarbons utilizing a variety of different placements and mixtures within a non-gel hydraulic fracture.

7. The hydraulic fracturing fluid enzyme composition of claim 1, wherein said oleophilic enzyme improves mobility of the oil and provides better permeability such that oil and gas production is optimized.

8. The hydraulic fracturing fluid enzyme composition of claim 1, wherein adding said oleophilic enzymes to said non-gel fracturing fluid improves pumping of said non-gel fracturing fluid, creating fissures and dispersing said hydraulic fracturing fluid enzyme composition throughout said subterranean formation.

9. The hydraulic fracturing fluid enzyme composition of claim 1, wherein said composition eliminates the need for removal of post fracturing polymer-related residues known to clog said fissures.

10. The hydraulic fracturing fluid enzyme composition of claim 1, wherein said oleophilic enzyme fluid is injected at ambient temperature or pre-heated to 80-90 degrees C. (174-194 degrees F.).

11. The hydraulic fracturing fluid enzyme composition of claim 1, wherein said oleophilic enzyme concentration is typically between 5 and 10 percent within said non-gel fracturing fluid concentration.

12. The hydraulic fracturing fluid enzyme composition of claim 1, wherein said oleophilic enzyme fluid comprises various concentrations and may be injected at different stages of said hydraulic fracturing process.

13. The hydraulic fracturing fluid enzyme composition of claim 1, wherein said hydraulic non-gel fracturing fluid enzyme composition is injected at a rate and pressure sufficient to fracture the formation, but has less pressure requirements than the hydraulic gel fracture pressure needed to fracture a similar well.

14. The hydraulic fracturing fluid enzyme composition of claim 1, wherein injecting said hydraulic fracturing fluid enzyme composition down the open wellbore sections coats said open wellbore sections providing reduced surface tension, reduces near-wellbore blockage and improves mobility and flow of said oil and/or hydrocarbons flowing to and within said open wellbore sections.

15. The hydraulic fracturing fluid enzyme composition of claim 1, wherein said oleophilic enzyme fluid is non-reactive with gas, but enhances releasing of dissolved gas from oil or other hydrocarbon deposits.

16. The hydraulic fracturing fluid enzyme composition of claim 1, wherein said oleophilic enzyme fluid decreases the contact angles of oil and gas with preventing oil and/or hydrocarbons from re-adhering within said fractures.

17. The hydraulic fracturing fluid enzyme composition of claim 1, wherein said oleophilic enzyme fluid does not ingest oil or alter the chemical composition of said oil.

18. The hydraulic fracturing fluid enzyme composition of claim 1, wherein said oleophilic enzyme fluid flows in an unrestricted manner during said hydraulic fracturing processes by the API, said oil gravity or said hydrocarbons produced.

19. The hydraulic fracturing fluid enzyme composition of claim 1, wherein the heat tolerance of said oleophilic enzyme fluid is at least 270 degrees C. at pressures above atmospheric pressure.
